(19) United States
(12) Patent Application Publication
(10) Pub. No.: US 2014/0150498 A1
(43) Pub. Date: Jun. 5, 2014

(54) PROCESS FOR THE PRECISION MOULDING OF GLASS MANUFACTURED ARTICLES WITH GREAT SIZES, IN PARTICULAR LENSES

(71) Applicants: Gino D'ovidio, Roma (RM) (IT); Giovanni Lanzara, Roma (RM) (IT); Carlo Tulli, Roma (RM) (IT); Giuseppe Femia, Roma (RM) (IT)

(72) Inventors: Gino D'ovidio, Roma (RM) (IT); Giovanni Lanzara, Roma (RM) (IT); Carlo Tulli, Roma (RM) (IT); Giuseppe Femia, Roma (RM) (IT)

(73) Assignee: SOLERGY INC., Piedmont, CA (US)

(21) Appl. No.: 14/112,070

(22) PCT Filed: Apr. 27, 2012
(86) PCT No.: PCT/IB12/52130

§ 371 Date: Dec. 31, 2013

(30) Foreign Application Priority Data
Apr. 28, 2011 (IT) RM2011A000218

(51) Int. Cl. C03B 11/12

(52) U.S. Cl. CPC C03B 11/122
USPC 65/29.1; 65/29.19

(57) ABSTRACT

A process for the precision moulding of glass manufactured articles, in particular glass lenses with great sizes and thickness, characterized by reduced surface roughness and high geometrical precision of the shapes, providing a phase wherein one controls actively the geometry of a glass spindle with temperature higher than or equal to its working temperature by means of a mould, and wherein subsequently the temperature and the shape of the spindle during the cooling phase is controlled actively, so that the manufactured article reaches uniformly and in all its volume a single temperature Td, not lower than its glass transition temperature.

### OBJECT OF THE INVENTION

The present invention relates to a process with great precision for producing, by means of moulding, glass manufactured articles such as in particular glass lenses even with great sizes and mass, therefor an extremely reduced geometric error is requested. Apparatuses for moulding and implementing such process are described too.

### DESCRIPTION OF THE STATE OF ART

In the general field of the optical devices, the lenses used to modify the optical path of the light rays have great importance: in several application fields, such as photography or microscopy, it is necessary to collimate or diverge the electromagnetic radiation in extremely precise way.

In the optical lenses, this effect is obtained by exploiting the refraction physical principle, therefore the direction of the light propagation carrier is modified upon passing among means made of material with a different refraction index, such as air or void and a transparent material.

By properly varying the geometrical profile of the surfaces of these objects, one can make that the incident rays are mutually deviated according to the optical design of the system.

From what said above, it results clear that optical lenses, for the correct operation thereof, must have in general very high transparency, geometrical precision and a roughness with size at least comparable to the one of the wavelength of the incident light electromagnetic radiation.

Currently, for manufacturing optical lenses, several transparent materials are used, for example glass or plastic materials; the latter have spread greatly in the last decades, thanks to the easiness therewith they can be transformed by means of mass industrial processes.

However, the transparent polymeric materials have intrinsic limits, such as the chemical instability in the brief period, for example due to the sensibility thereof to acids or bases, or in the long period, in particular due to the deterioration caused by ultraviolet waves associated to light radiation. These drawbacks are reduced by means of additives added to the materials, but inevitably by increasing the related relationship between cost and performances.

On the contrary, glass is an ideal material in optics, as it is transparent for a wide spectrum of electromagnetic frequencies and as it is chemically inert to most part of the known chemical agents. Its already remarkable physical/chemical features can be further increased even in this case by using suitable additives; however, in case of lenses with great size, it results to be complex obtaining them with moulding processes without additional processings of mechanical type.

As glass is a material which has been known since ancient times, throughout history several methods for producing the artefacts thereof have been proposed.

The U.S. Pat. No. 4,738,703 relates a process for moulding an optical lens, wherein an initial heating of a piece of glass is provided, followed by the related positioning inside a mould, the temperature thereof is kept equal or higher than the glass transition temperature. Subsequently, the piece of glass is preformed in the mould by means of pressing, so as to give thereto a shape substantially analogous to the wished final one. At last, an additional pressing and final forming of the lens is performed.

The U.S. Pat. No. 4,854,958 relates to a process for moulding glass articles, according thereto a piece of glass, having a shape similar to the wished final one, is arranged in a mould, which is then brought, together with the piece of glass, at a predetermined temperature. At this point, a load is applied to the piece so as to make it to assume the shape of the mould containing it. The so-treated piece of glass is removed by the related mould at a higher temperature than the glass transformation threshold and, at last, subjected to an annealing treatment.

The patent application EP 0508066 A2 describes a process for moulding articles made of glass having a shape proximate the final one. The process provides a heating, at different temperatures, of the receiving surface and of the surface opposite thereto belonging to a mould, followed by a pressing, between such two surfaces, of a piece of glass for a predetermined period of time.

For what concerns the lenses used in optical environment, the currently most used processes are the so-called traditional moulding, the working from solid, the precision moulding in mould by using preforms, which however is ready to be used only to obtain particular lenses with reduced sizes and thickness, and the precision moulding in mould by using glassed with low vitreous transition temperature (Tg).

In the traditional moulding, the molten glass is transferred to a mould at a well-determined temperature, in the latter it is pressed until it is not adequately solidified. Subsequently, the obtained object, still at high temperature, is extracted from the mould and inserted into an annealing oven, so that it cools down according to a well-defined thermal gradient.

In order to better understand the here synthetically described process, it is necessary to make reference to FIG. 1 which will illustrated herebelow, in the diagram thereof the viscosity-temperature curves are shown for different glasses of common use. From the diagram well specific values of viscosity and temperature corresponding to different phases of the moulding process can be defined. Such values are the following ones:
melting point: it is defined as the temperature thereat the glass is sufficiently fluid to be vehiculated inside a furnace;
working point: it is the temperature condition usually used for the initial glass moulding phase;
softening point: it defines the lower temperature limit thereat moulding can take place; at equal or higher temperatures there is a viscosity so that the glass can deform under the action of its own weight;
annealing point: it is the temperature thereat a glass sample, in a time range equal or higher than 15 minutes, sets to zero its own inner strains without considerable geometrical distortions taking place thereupon;
strain point: it is the lowest temperature thereat an annealing process can take place; under these conditions, the glass sample takes several hours to halve its own residual strains;
glass transition temperature (Tg): not shown in figure, it is the temperature therebelow the glass stops to be considered fluid and it assumes the usual stiffness and brittleness characterizing it.

In the traditional moulding process the molten glass, which is inside the furnace under melting conditions (Melting Point), is transferred to the mould, by using anthropomorphic robots or other feeding devices, and then it is pressed for temperature values comprised between the working temperature (Working Point) and the softening temperature (Softening Point). At this point, and before the glass has cooled down so as to reach in some part thereof the glass transition temperature (Tg), the moulded object is transferred from the mould to the annealing furnace, wherein it releases the strains accumulated during the previous forming phase and it cools down slowly under controlled conditions until room temperature.

The described moulding process, widely used thanks to the versatility thereof, has considerable drawbacks if it is applied to the production of optical lenses of great sizes and with thicknesses considerably variable in the diametral direction.

First of all, at the end of the phase for transferring from the furnace, the molten glass portion being in contact with the coldest surfaces of the mould cools down before the material portion remaining inside the pressed object, by generating characteristic surface stripings (cold waves). One can obviate this problem by pre-heating the mould, but there is a higher limit than the obtainable temperature, therebelow the glass tends to stick to the mould walls (sticking).

A second important limit of the traditional process consist in the geometrical distortion of the finished product. In fact, the glass is a thermically insulating material and the variation curve of the specific volume (see FIG. 3) is not linear with the temperature and it has the maximum withdrawal at the temperature range therefor the moulding takes place, with a withdrawal percentage depending upon the cooling speed.

Due to the combination of these factors, when a pressed object with irregular shape cools down after having been pressed, it contracts not uniformly according to its own thickness: for example, whereas the portions with smaller thickness have reached the glass transition point and therefore the size variation thereof is very limited, the portions with larger size are still at high temperatures and then subjected to additional deformations during the cooling; the differentiated contractions which are so implemented create big deformations when the whole mass reaches the glass transition point.

Therefore, with conventional mouldings, in order to make functional the moulded portion, a new processing of the object geometry becomes necessary, through extremely long and expensive grinding and polishing processes.

For the shown reasons, the use of the previously described traditional moulding process is limited to the production of details wherein it is not important to obtain a high geometrical precision of the shapes, such as for example artistic products, or products with reduces sizes and thickness, wherein the glass differential shrinkage is limited by the poor quantity of moulded material.

By performing a double moulding, during cooling, it is possible improving the final quality of the product and obtaining good precisions in presence of masses of small entity and not excessive surface sizes, for example objects with mass smaller than 0.5 kg and diameter smaller than 15 cm.

In the so-called working from solid, the detail is obtained by means of the mechanical working of a preform, which generally is moulded. On the market there are several working centres CNC specialized according to different techniques in the glass grinding and polishing; generally they are equipped with their own CPU and software, able to acquire a three-dimensional CAD model of the object to be implemented, and to translate it automatically in the optimized tool path. However, they are extremely expensive machines with reduced productive capability, therefore the use thereof is limited to obtain objects with scientific interest and to manufacture prototypes.

The so-called precision forming in mould (precision moulding) by using preforms is suitable for details with small sizes and it mainly constitutes a variant of the traditional moulding wherein the moulding process is divided into two distinct phases:
i. moulding of the preform: generally one tries to mould an object from the form as much as similar to the finished product, but without particular attention to the geometrical precision.
ii. heating and re-moulding of the preform: the preform is brought in the whole thickness thereof at a higher temperature than the glass transition temperature (Tg) by means of specific heating systems, for example infrared or hydrogen systems, and therefore it is pressed again; in this case the glass deformation in the moulding phase is considerably reduced thanks to the fact that the preform follows already approximately the profile to be obtained, thus by minimizing the distortion caused by the material differential shrinkage.

The described phases, like the traditional moulding process, are followed by the annealing treatment.

In order that the process has success, it is necessary that the preform, at the end of the heating phase, is uniformly and in the entirety thereof at the same temperature, so as to avoid the distortions caused by the thermal gradients during the moulding. For objects with great size and thickness this requests a slow heating, in order to avoid the preform rupture due to the different thermal expansions, cause which in such cases makes the method substantially not practicable.

The precision forming in mould with glasses with low glass transition temperature (Tg) is a recent solution to the moulding problem; in this case it acts on the chemical composition of the used glass, in order to make it optimum for the precision moulding.

By properly varying the doses and the type of glass base materials, one succeeds in lowering the glass transition temperature, by making possible the moulding of details at relatively low temperatures, with consequent minimization of the final geometrical error.

The materials used in this process are naturally more expensive than the traditional ones, and sometimes the physical/chemical features thereof can be not compatible with the uses of the particular moulded article, for example when it is necessary the maximum transmission of the incident radiation, such as in the exploitation of the solar radiation, or particular stiffness and resistance to the thermal shocks.

### SUMMARY OF THE INVENTION

With respect to the previously described processes, the following objectives are set:
to reduce time and costs for working the moulded lens;
to increase the precision and repeatability of the lens final geometry,

so as to obviate the drawbacks found in the state of art.

In the light of what previously illustrated, the present invention relates then to a process for the precision moulding of glass manufactured articles, in particular glass lenses with great size and thickness, characterized by reduced surface roughness (<20 nm) and high geometrical precision, therefore no additional finishing processes are necessary, such as grinding and/or polishing the profiles.

Such process mainly consists in forming a lens or analogous manufactured article starting from a glass spindle with temperature higher or equal to its working temperature (Working point), and subsequently in controlling actively the geometry of the manufactured article, by means of a mould and the temperatures of the manufactured article in the cooling phase, until the manufactured article is uniformly and in all its volume at a temperature Td not lower than its glass transition temperature (Tg). In a first embodiment of the proposed process the above-mentioned mould consists in a isothermal chamber, able to keep constant the temperature of the surfaces in contact with the glass at a slightly higher value Td than the glass transition temperature (Tg) during the formation of the lens as from the glass spindle, and in conducting such forming phase in pressure for a sufficiently long time interval so that the lens, or the analogous manufactured article, reaches uniformly and in all its volume the conditions of thermal equilibrium with the mould.

In the field of the same inventive concept, a different embodiment consists in forming the lens or an analogous manufactured article inside a mould starting from a glass spindle, by subsequently making such manufactured article to stay inside a chamber able to keep constant its own temperature at a value of prefixed temperature Td not lower than, that is slightly higher than, the glass transition temperature (Tg) related to the glass requested composition, for a time interval so that the manufactured article reaches uniformly and in all its volume the conditions of thermal equilibrium with the chamber until the prefixed temperature and in subsequently performing a second lens forming in order to correct the geometrical deformations which have taken place in the phase for reaching the above-mentioned pre-fixed temperature.

To make clearer and comprehensible the above-mentioned objectives, one proceeds with a detailed description of the invention by referring to the figures enlisted herebelow; the shown figures are exemplifying and not limiting the concepts inherent the object invention.

### BRIEF DESCRIPTION OF THE ENCLOSED DRAWINGS

FIG. 1 shows a typical logarithmic diagram Viscosity/Temperature for different glass typologies.

FIG. 2 shows a thermal map of a lens during the pressing phase, in case of using a standard moulding process.

FIG. 3 shows a diagram Specific Volume/Temperature for a general optical glass.

FIG. 4 shows schematically the different phases of a first embodiment of a process for moulding glass lenses according to the invention.

FIG. 5 shows a block diagram illustrating the different phases of a second embodiment of a process for moulding glass lenses according to the invention.

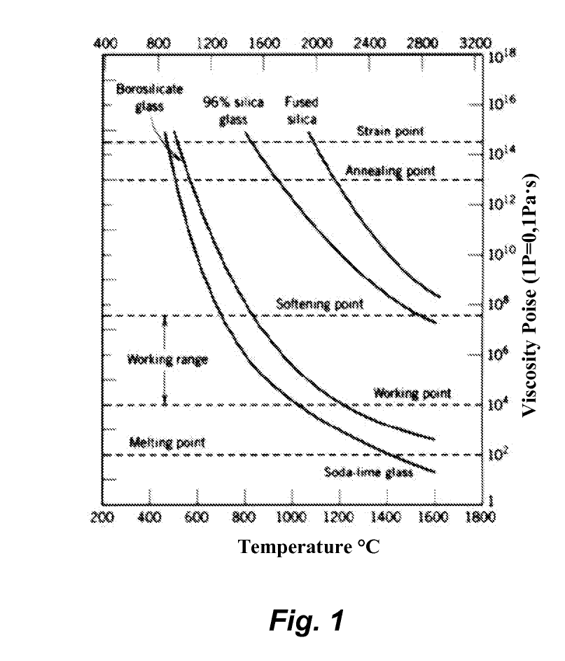

### DESCRIPTION OF EMBODIMENT EXAMPLES OF THE INVENTION

The subject invention relates to a general process and to its implementation in industrial systems for moulding glass precision lenses with great sizes and thickness, characterized by reduced surface roughness (<20 nm) and very high geometrical precision of the shapes, with respect to a predefined geometrical design, without the need of additional finishing processes, such as grinding and/or polishing of the profiles.

In a standard moulding process, when the glass is transferred to the mould, it starts immediately to cool down at the contact surfaces.

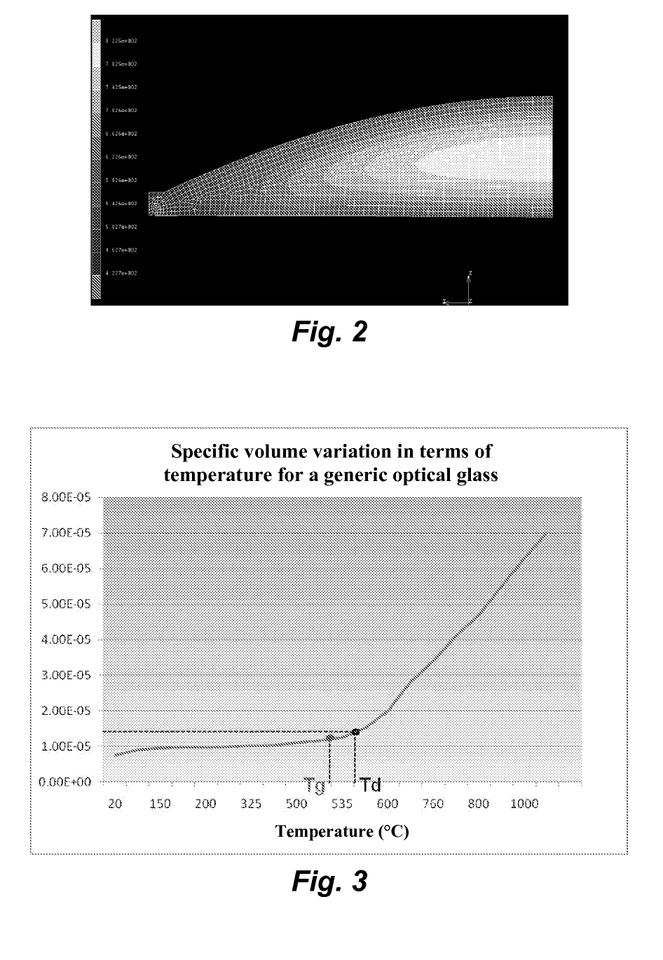

Then, due to the low thermal conductibility of the material, during the moulding and consequent cooling phases, the temperature inside thereof varies from point to point, by keeping at higher values at the sections of larger thickness (FIG. 2).

These thermal gradients, when the pressed material is still under the viscous state, cause differentiate shrinkages which cause the geometrical distortions at the end of the cooling process.

Until the product is in the semi-fluid state in each part thereof, the shape variations can be corrected by the pressure applied by the mould, but as soon as its temperature reaches in some regions the glass transition temperature typical of the used glass composition, the corresponding volume stops to be deformable and each additional applied force risks to cause the rupture of the detail.

In order to obviate the described drawbacks, the present invention consists in obtaining the controlled lens in geometry by bringing the whole glass mass in the mould at a slightly higher temperature than the Tg, which will be called Td, in all its volume, starting from a glass spindle at a higher temperature than its working temperature (working point). Under such conditions, the thermal contraction due to the cooling of all glass mass, when its temperature passes from the value Td to the room temperature, will results to be extremely reduced; in fact, by analysing the graph which represents the glass specific volume variation in terms of temperature (FIG. 3), it can be noted that below the Tg the curve tends to become asymptotic, the volume variations reduce considerably and the thickness variation is no more important as the differential contractions are extremely reduced from point to point.

Among all possible embodiments of the described general moulding process, the following two variants can be distinguished:

### First Embodiment

In this embodiment of the present invention, a mould is used in order to obtain a lens controlled in geometry and temperature.

Such mould acts as isothermal chamber, by means of suitable temperature control devices and systems which, in themselves, are of conventional nature.

In the above-mentioned mould, the whole glass mass is left to cool down until reaching in all its volume a temperature not lower than the above-mentioned glass transition temperature (Tg), that is at a slightly higher pre-fixed temperature Td than the glass transition temperature, starting from a glass spindle at a higher temperature than its working temperature (Working point).

Under such conditions, the thermal contraction due to the cooling of all the glass mass, when its temperature passes from the value Td to the room temperature, will result to be extremely reduced.

In fact, by analysing the graph representing the variation in the glass specific volume in terms of temperature (FIG. 3), it can be noted that below the glass transition temperature the curve tends to become asymptotic, the volume variations reduce considerably and the thickness variation is not important anymore as the differential contractions from point to point are extremely reduced.

From what written above, the importance of controlling the temperatures and the mould shape results clear, considering that they influence the final geometry of the lens: therefore even the mould shape has to be accurately defined already in the plan phase.

The mould can be sized by using the results of the finite element numerical analyses (FEM), able to provide the final geometry of the lens, once defined the moulding process parameters (time, temperatures and moulding pressures) and the mould shape; with some iterations one is thus able to reduce the geometrical differences between the moulded object and the nominal profile of the lens within a wished precision.

The general moulding process, applied to the present embodiment, is mainly composed of four phases, and it provides the use of a mould as defined previously, as isothermal chamber able to keep constantly at the prefixed temperature not lower than the glass transition temperature, notwithstanding the thermal exchange with the glass is differentiated, as function of the geometry of the pressed object and therefore variable with the thickness.

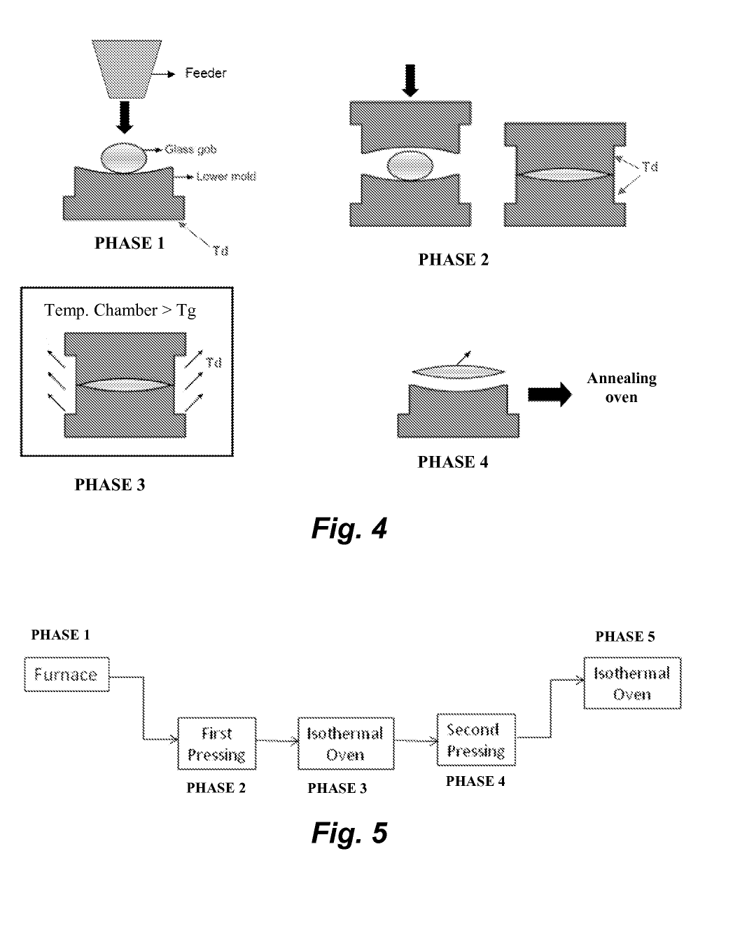

PHASE 1: By referring to FIG. 4, a drop of molten glass, at its working temperature, is transferred to the lower portion of the above-mentioned mould which is already at the prefixed temperature Td.

The mould can be pre-heated at the wished temperature, by means of a system of resistances controlled in temperature, properly sized and arranged inside thereof, or by inserting the mould itself inside a thermal chamber.

PHASE 2: The glass is at first pressed by applying upon the above-mentioned lower portion the mould upper portion, which is at the prefixed temperature too.

PHASE 3: The molten glass is kept under pressure inside the mould and it is made to cool down until bringing the temperature in each part thereof at the prefixed temperature, by making the mould to act as an isothermal chamber. In this way, one could be sure that no portion of the glass volume goes below a temperature equal or lower than the glass transition temperature.

During this cooling phase, a control under pressure of the mould is kept, which is necessary to constrain the lens geometry, which otherwise would be compromised by the differential shrinkage of the glass during cooling.

In a slight variant of the present embodiment, whenever it is not possible implementing in the mould an adequate control in the temperatures, the whole cooling of the assembly mould-lens could be implemented inside a thermal chamber, that is an oven able to keep constant the temperature of the assembly itself inside thereof, at the above-mentioned value of prefixed temperature.

Said prefixed temperature Td has a value depending upon the geometrical precision which one wishes to obtain in the finished manufactured article: as it can be seen from examining FIG. 3, the more it is near the Tg of the used glass, the lower will be the differential shrinkages which will take place inside the manufactured article and consequently the more precise will be the shape of the moulded object: once the specific volume variation curve in terms of the temperature is known, relatively to the glass to be used, and the wished precision in the finished manufactured article, the temperature Td can be then calculated in advance.

After a sufficiently long period of time, which will depend upon the working temperature and upon the masses at stake of the mould and of the glass, the whole glass mass will have reached the prefixed temperature under conditions of thermal equilibrium.

PHASE 4: The mould is open and the lens is extracted, which will follow an annealing cycle so as to avoid that stresses and differential shrinkages due to the thermal gradients arise. In this phase, the lens geometry can be controlled as the glass shrinkage from the glass transition temperature to the room temperature is of reduced extent and can be calculated.

### Second Embodiment

By referring to FIG. 5, the general process applied to the present embodiment is composed of five phases, and it provides two different moulding phases, alternated by a phase for cooling the object preformed in an isothermal chamber, for example inside an oven able to keep constant the temperature at the wished value of prefixed temperature Td not lower than the glass transition temperature; even in this case, the temperature maximum value Td can be calculated in advance depending upon the requested precision in the finished manufactured article, if the specific volume variation curve in terms of the temperature is known, relatively to the used glass, according to what already described concerning the previous invention embodiment.

PHASE 1: A drop of molten glass, at its working temperature, is transferred to the lower portion of a mould.

PHASE 2: It is a preforming phase, wherein the glass is at first pressed by applying on the above-mentioned lower portion the upper portion of the mould.

PHASE 3: Once ended the phase 2, the preformed manufactured article is extracted from the mould and it is then inserted in an isothermal oven kept at the prefixed temperature Td. The manufactured article is kept in such environment at constant temperature for a sufficiently long period of time, until the whole glass mass, in each portion thereof, reaches a uniform temperature equal to said prefixed temperature.

PHASE 4: The manufactured article is extracted from the isothermal oven and it is inserted into an additional mould or alternatively the manufactured article is re-inserted inside the mould wherein the preforming has been performed (Phase 2), and a second moulding of the manufactured article is performed in order to correct the shape variations caused by the glass shrinkage during its cooling until the prefixed temperature Td.

PHASE 5: The additional mould is open and the lens is extracted, which will follow an annealing cycle so as to avoid that stresses and differential shrinkages due to thermal gradients arise. In this phase, the lens geometry can be controlled as the glass shrinkage from the glass transition temperature to the room temperature is of reduced extent and it can be calculated.

The general process and the subject invention embodiments have been applied with success in the moulding of a plane-convex glass lens having a diameter of 264 mm and maximum thickness of about 35 mm; said lens has been implemented by using different glass typologies, such as for example:
soda lime glass (Tg: 513° C.; Td: 540° C.)
borosilicated glass (Tg: 525° C.; Td: 540° C.)

For both glasses a specific volume variation curve in terms of temperature has been obtained and the temperature value Td has been calculated so as to remain inside the requested geometrical tolerances.

The fact of choosing the Td values indicated above has allowed in both cases to obtain in the finished lens a shape error lower than 0.01 mm.

To the above described process, a person skilled in the art, in order to satisfy contingent needs, can introduce any modification and variant, provided that they are within the protective scope of the present invention, as defined by the enclosed claims.

1. A process for the precision moulding of glass manufactured articles, in particular glass lenses with great sizes and thickness, characterized by a low surface roughness and high geometrical precision of the shapes, wherein one controls actively the geometry of a glass spindle with temperature higher than or equal to its working temperature by means of a mould, and wherein subsequently the temperature and the shape of the spindle during the cooling phase are controlled actively, so that the manufactured article reaches uniformly and in all its volume a single temperature Td, not lower than its glass transition temperature.

2. The process according to claim 1, wherein said temperature control is performed in an isothermal chamber, able to keep constant the temperature of the surfaces in contact with the glass at a single temperature value Td not lower than the glass transition temperature during the forming of the manufactured article from the glass spindle, and wherein such forming phase is performed for a sufficiently long time interval so that the manufactured article reaches uniformly and in all its volume the conditions of thermal equilibrium with the thermal chamber.

3. The process according to claim 1, wherein the manufactured article, after the moulding of the glass spindle, is extracted from the mould and subsequently kept inside an isothermal chamber, that is able to keep constant its own temperature at a single value of prefixed temperature Td not lower than the glass transition temperature relative to the requested glass composition, for such a time interval that it may reach uniformly and in all its volume the conditions of thermal equilibrium with the chamber up to the prefixed temperature, and wherein a subsequent phase of forming the manufactured article is provided in order to correct the geometrical deformations which have taken place in the phase of reaching the prefixed temperature.

4. The process according to claim 2, wherein said isothermal chamber is a mould provided with suitable devices and systems for controlling temperature.

5. The process according to claim 2, wherein said isothermal chamber is an isothermal oven wherein said mould is inserted.

6. The process according to claim 2, wherein four distinct phases are provided:
PHASE 1: a drop of molten glass, at its working temperature, is transferred to the lower portion of a mould which is at said prefixed temperature (Td);
PHASE 2: the glass is at first pressed by applying on the above-mentioned lower portion the mould upper portion, which is at the prefixed temperature too (Td);
PHASE 3: the molten glass is kept under pressure inside the mould and it is cooled down until the temperature in each portion thereof reaches the prefixed temperature (Td), by making the mould act as an isotherm chamber, by keeping control under pressure of the mould to constrain the lens geometry;
PHASE 4: opening the mould and extracting the manufactured article, followed by an annealing cycle, so as to avoid that stresses and differentiated shrinkages due to the thermal gradients arise.

7. The process according to claim 3, wherein five distinct phases are provided:
PHASE 1: a drop of molten glass, at its working temperature, is transferred to the lower portion of a mould;
PHASE 2: the glass is preformed by applying on the above-mentioned lower portion the mould upper portion;
PHASE 3: the preformed manufactured article is extracted from the mould and it is then inserted in an isothermal oven kept at the prefixed temperature Td, wherein it is kept at a constant temperature for a sufficiently long period of time, until the whole glass mass reaches a uniform temperature equal to said prefixed temperature;
PHASE 4: extraction of the manufactured article from the isothermal oven and re-insertion of the manufactured article in a mould, kept at prefixed temperature Td, therewith a second precision moulding is performed in order to correct the lens shape variations caused by the glass shrinkage during its cooling up to the prefixed temperature;
PHASE 5: opening the mould and extracting the manufactured article, followed by an annealing cycle so as to avoid that stresses and differentiated shrinkages due to the thermal gradients arise.

8. The process according to claim 1, wherein said pre-fixed temperature Td has a value depending upon the requested geometrical precision for the finished manufactured article and which can be calculated starting from the specific volume variation curve with respect to temperature, relatively to the glass used for moulding the manufactured article.

9. The process according to claim 1, wherein the manufactured article is a precision lens with great sizes.
